(19) United States
(12) Patent Application Publication
(10) Pub. No.: US 2017/0103024 A1
(43) Pub. Date: Apr. 13, 2017

(54) INFORMATION PROCESSING APPARATUS AND CACHE CONTROL METHOD

(71) Applicant: FUJITSU LIMITED, Kawasaki-shi (JP)

(72) Inventor: Yuki MATSUO, Bunkyo (JP)

(73) Assignee: FUJITSU LIMITED

(21) Appl. No.: 15/263,452

(22) Filed: Sep. 13, 2016

(30) Foreign Application Priority Data
Oct. 7, 2015 (JP) 2015-199321

(51) Int. Cl. G06F 12/123; G06F 12/0862; G06F 12/0893

(52) U.S. Cl. CPC G06F 12/123; G06F 12/0893; G06F 12/0862; G06F 2212/1021; G06F 2212/602; G06F 2212/69

(57) ABSTRACT

A processor generates stream information indicating a stream of access events, based on a positional relationship between a plurality of first data blocks that are accessed in a storage device. The processor monitors access to a plurality of second data blocks that are prefetched based on the stream information, and determines whether the stream is ended based on elapsed time from last access to any of the plurality of second data blocks. The processor removes at least one of the plurality of second data blocks from the memory when the stream is determined to be ended.

### CROSS-REFERENCE TO RELATED APPLICATION

This application is based upon and claims the benefit of priority of the prior Japanese Patent Application No. 2015-199321, filed on Oct. 7, 2015, the entire contents of which are incorporated herein by reference.

### FIELD

The embodiments discussed herein are related to an information processing apparatus and a cache control method.

### BACKGROUND

Many information processing systems use a relatively slow storage device (for example, an auxiliary storage device such as a hard disk drive (HDD), a solid state drive (SSD), and the like) to store a large amount of data. If access is made to a slow storage device every time an access request is issued, data access may become a bottleneck to the processing performance. In view of this, part of data stored in a slow storage device is often cached in a relatively high-speed memory (for example, a main storage device such as a random access memory (RAM)). The data cached in the memory may be provided without accessing the storage device where the data was originally stored.

For example, predetermined data that is likely to be used may be cached in a memory. Further, for example, data that has been used may be retained in a memory, on the premise of access locality, that is, on the premise that data that has been used is likely to be used again. In many cases, a memory for caching data has a smaller capacity than a storage device where the data was originally stored, and therefore replacement of cached data occurs. As a method for selecting data to be removed from a memory, a page replacement algorithm such as a least recently used (LRU) algorithm and the like is used. The LRU algorithm preferentially removes the least recently used data (data that has not been used for the longest continuous period of time).

Sequential data access is one way of accessing data. The types of sequential data access include sequentially accessing continuous areas in the original storage device, accessing areas spaced at regular intervals, and so on. If such sequential data access is detected, the next data to be requested may be predicted and read in advance (prefetched) into the memory without waiting for an access request. With prefetch, it is possible to increase the speed of data access to even data that is not repeatedly used for a short period of time.

There has been proposed a replacement determining circuit that determines a data block to be removed from among a plurality of data blocks prefetched in a buffer. When two or more data blocks are selected by an LRU algorithm as candidates for removal, the proposed replacement determining circuit preferentially removes one of the selected candidates that has never been accessed in the buffer.

There has also been proposed a data processing apparatus including a cache control unit that is provided separately from a processor and that prefetches data to be used by the processor into a cache memory. The cache control unit preferentially removes data used by the processor among the data stored in the cache memory. Further, there has been proposed a cache memory system that specifies storage areas which may be used for prefetch, from among a plurality of storage areas. Upon prefetching new data, the proposed cache memory system removes data stored in the storage areas specified for prefetch, and does not remove data stored in the other storage areas.

See, for example, Japanese Laid-open Patent Publications No. 63-318654, No. 9-212421, and No. 2001-195304.

In sequential data access, data stored across a large area is often requested. Thus, as long as sequential data access continues, data is prefetched into the memory one after another. However, sequential data access eventually ends when the request source process ends or when some other events occur. The prefetched data is less likely to be used by another process or the like soon after the sequential data access ends.

In this case, if a common page replacement algorithm is applied collectively to the prefetched data and the other data, data more likely to be used might be removed from the memory before data less likely to be used is removed. This reduces the usage efficiency of the cache memory. Further, if storage areas for prefetch are separated from the other storage areas as in the case of the cache memory system described above, a situation may occur in which although there is available space in the storage areas of one of the two types, there is no available space in the storage areas of the other type. This might reduce the usage efficiency of the cache memory.

### SUMMARY

According to one aspect of the embodiments, there is provided an information processing apparatus including: a memory configured to cache data blocks stored in a storage device; and a processor configured to perform a procedure including: detecting a stream of access events satisfying a predetermined rule condition, based on a positional relationship between a plurality of first data blocks that are accessed in the storage device, and generating stream information indicating the stream; monitoring access to a plurality of second data blocks that are prefetched from the storage device into the memory based on the stream information, and determining whether the stream is ended based on elapsed time from last access to any of the plurality of second data blocks; and removing at least one of the plurality of second data blocks from the memory when the stream is determined to be ended.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus according to a first embodiment;

FIG. 2 is a block diagram illustrating an example of hardware of the information processing apparatus;

FIG. 3 illustrates an example of cache page management;

FIG. 4 illustrates an example of sequential data access and prefetch;

FIG. 5 illustrates an example of an LRU algorithm;

FIG. 6 illustrates an example of pages related to a stream that has disappeared;

FIG. 7 is a block diagram illustrating exemplary functions of the information processing apparatus;

FIG. 8 illustrates an example of a management structure;

FIG. 9 illustrates an example of a hash table;

FIG. 10 illustrates an example of an LRU management list and a preferential replacement page list;

FIG. 11 illustrates an example of a stream table;

FIG. 12 is a flowchart illustrating an example of the procedure of prefetch control;

FIG. 13 is a flowchart illustrating an example of the procedure of replacement page determination;

FIG. 14 is a flowchart illustrating an example of the procedure of cache hit determination;

FIGS. 15 and 16 are flowcharts illustrating an example of the procedure of sequentiality detection; and

FIG. 17 is a flowchart illustrating an example of the procedure of stream disappearance determination.

### DESCRIPTION OF EMBODIMENTS

Several embodiments will be described below with reference to the accompanying drawings, wherein like reference numerals refer to like elements throughout.

### (a) First Embodiment

The following describes a first embodiment.

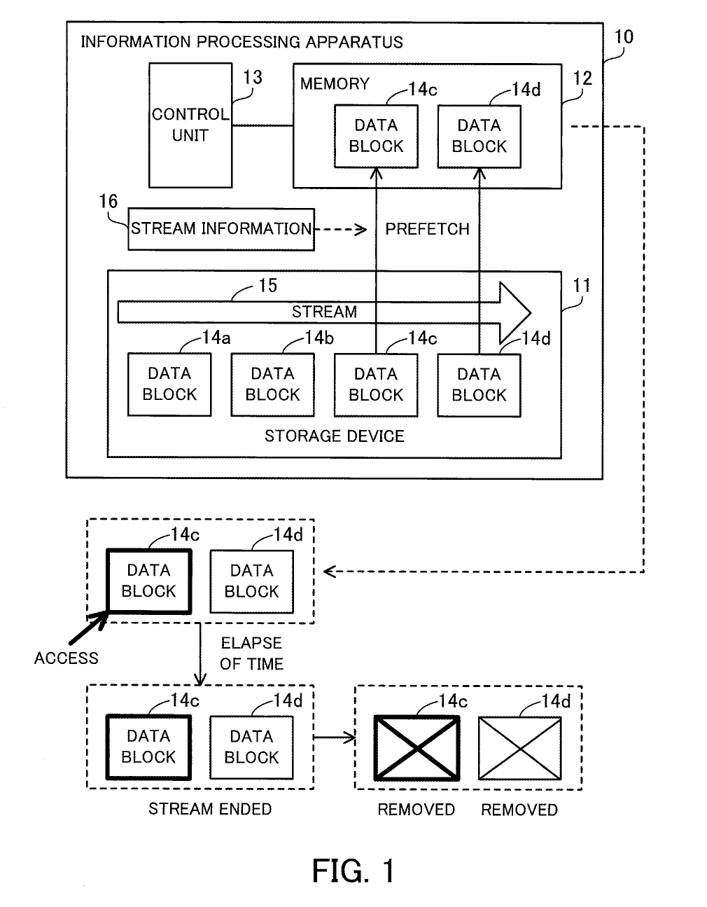

FIG. 1 illustrates an example of an information processing apparatus 10 according to a first embodiment.

The information processing apparatus 10 according to the first embodiment accesses data in response to a request from a process running on the information processing apparatus 10 or another information processing apparatus. Accessing data includes reading data and writing data. The information processing apparatus 10 may be a server apparatus such as a server computer and the like, or may be a client apparatus such as a client computer and the like. The information processing apparatus 10 may be a storage apparatus.

The information processing apparatus 10 includes a storage device 11, a memory 12, and a control unit 13. The storage device 11 only needs to be accessible from the information processing apparatus 10, and may be provided outside the information processing apparatus 10. The storage device 11 is a storage device with relatively slow access time. For example, the storage device 11 is a non-volatile storage device such as an HDD, an SSD, and the like. The memory 12 is a memory with faster access time than the storage device 11. For example, the memory 12 may be a volatile semiconductor memory such as a RAM and the like. The memory 12 has a smaller storage capacity than the storage device 11.

The control unit 13 is a processor such as a central processing unit (CPU), a digital signal processor (DSP), and the like, for example. However, the control unit 13 may include an application specific electronic circuit such as an application specific integrated circuit (ASIC), a field programmable gate array (FPGA), and the like. The processor executes programs stored in a memory such as a RAM and the like. The programs include a cache control program. A set of multiple processors (a multiprocessor) may also be referred to as a “processor”.

The storage device 11 stores a plurality of data blocks including data blocks 14a, 14b, 14c, and 14d. Each data block is a data unit that is loaded from the storage device 11 to the memory 12, and has a predetermined size, for example. A data block may be referred to as a page, a segment, or the like. The location of each of the data blocks 14a, 14b, 14c, and 14d may be specified by using a physical address in the storage device 11.

The data blocks 14a, 14b, 14c, and 14d are arranged in ascending order of physical address or in descending order of physical address. For example, the data block 14b has a greater physical address than the data block 14a; the data block 14c has a greater physical address than the data block 14b; and the data block 14d has a greater physical address than the data block 14c. The areas where the data blocks 14a, 14b, 14c, and 14d are present may be adjacent to each other or may be spaced apart from each other by a distance less than a threshold, in the storage device 11.

The memory 12 caches some of the plurality of data blocks stored in the storage device 11. In the case where the cache area of the memory 12 is full, if a data block that is not cached is requested, one or more data blocks stored in the memory 12 are removed from the memory 12. A predetermined page replacement algorithm such as an LRU algorithm is used for selecting a data block to be removed. The LRU algorithm preferentially removes the least recently used data block (a data block that has not been used for the longest continuous period of time) in the memory 12. However, as will be described below, a data block satisfying a predetermined condition may be removed preferentially over a data block selected by a common page replacement algorithm.

The control unit 13 detects, for two or more data blocks (first data blocks) that have been loaded into the memory 12 and accessed, a stream 15 of access events satisfying a predetermined rule condition, based on the positional relationship between these data blocks in the storage device 11. The stream 15 is, for example, one that accesses two or more data blocks in ascending order or descending order of physical address, in which the distance between two sequentially accessed data blocks is less than a threshold. The stream 15 may be referred to as sequential data access.

For example, if the data block 14b is accessed after the data block 14a is accessed, the stream 15 that accesses two or more data blocks around the data block 14a in ascending order of physical address is detected. The control unit 13 generates stream information 16 on the detected stream 15. The stream information 16 may be stored in the memory 12. The stream information 16 includes, for example, identification information of the stream 15, the physical address of the last data block accessed by the stream 15, and so on.

The control unit 13 reads in advance (prefetches) two or more data blocks (second data blocks) from the storage device 11 into the memory 12 without waiting for a request, based on the generated stream information 16. For example, the control unit 13 prefetches, into the memory 12, a data block whose physical address is greater than that of the last data block accessed by the stream 15 and whose distance from the last accessed data block is equal to or less than a threshold. For example, the control unit 13 prefetches the data blocks 14c and 14d from the storage device 11 into the memory 12.

The control unit 13 monitors access to the data blocks prefetched in the memory 12. In particular, the control unit 13 monitors the time interval of access to the data blocks (data blocks related to the stream 15) prefetched based on the stream information 16. The control unit 13 determines whether the stream 15 is ended, based on the elapsed time from the last access (the duration of time during which no access is made) to any of the prefetched data blocks. The end of the stream 15 indicates that sequential access is ended. This may be referred to also as “disappearance of a stream”. The end of the stream may indicate that a process having issued access requests belonging to the stream 15 is ended.

For example, the control unit 13 determines that the stream 15 is ended when the elapsed time is greater than a threshold, and determines that the stream 15 is not ended when the elapsed time is not greater than the threshold. The threshold may be determined based on the time interval (for example, the maximum time interval) of access to the prefetched data blocks in the past. For example, assume that although the elapsed time from access to the prefetched data block 14c has exceeded the threshold, the data block 14d is not accessed. In this case, the control unit 13 determines that the stream 15 is ended.

If the stream 15 is determined to be ended, the control unit 13 ends prefetch of data blocks based on the stream information 16, and removes from the memory 12 all or one or more of the data blocks prefetched based on the stream information 16. The data blocks to be removed may include those accessed and those not accessed after being cached into the memory 12. The data blocks related to the stream 15 that has ended are preferentially removed over a data block selected by a common page replacement algorithm.

The data blocks related to the stream 15 may be removed from the memory 12 when the stream 15 is determined to be ended, or when replaced with cached data blocks. For example, when there is not enough free cache space in the memory 12, the control unit 13 preferentially removes, from the memory 12, the data blocks 14c and 14d that are prefetched based on the stream information 16 over the other data blocks.

According to the information processing apparatus 10 of the first embodiment, access to the data blocks 14c and 14d in the memory 12 which are prefetched based on the stream information 16 on the stream 15 is monitored. A determination as to whether the stream 15 is ended (the stream 15 has disappeared) is made based on the elapsed time from the last access to any of the prefetched data blocks 14c and 14d. If the stream 15 is determined to be ended, at least one of the data blocks 14c and 14d is removed from the memory 12.

The data blocks prefetched based on the stream information 16 are likely to be accessed while the stream 15 is not ended. However, the likelihood of the prefetched data blocks being accessed decreases sharply when the stream 15 ends. The prefetched data blocks are less likely to be used by another process or the like soon after the stream 15 ends. By preferentially removing, from the memory 12, the data blocks 14c and 14d that have a reduced likelihood of being accessed, it is possible to create more free space in the memory 12. Accordingly, it is possible to prevent other data blocks likely to be accessed from being removed first from the memory 12, and thus to increase the usage efficiency of the cache area of the memory 12.

### (b) Second Embodiment

The following describes a second embodiment.

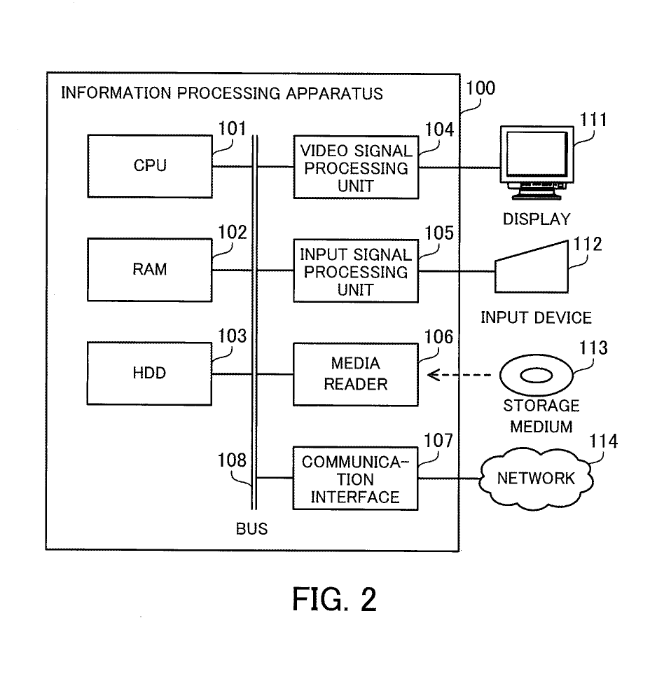

FIG. 2 illustrates an exemplary hardware configuration of an information processing apparatus 100.

The information processing apparatus 100 includes a CPU 101, a RAM 102, an HDD 103, a video signal processing unit 104, an input signal processing unit 105, a media reader 106, and a communication interface 107. The CPU 101, the RAM 102, the HDD 103, the video signal processing unit 104, the input signal processing unit 105, the media reader 106, and the communication interface 107 are connected to a bus 108. The information processing apparatus 100 corresponds to the information processing apparatus 10 of the first embodiment. The CPU 101 corresponds to the control unit 13 of the first embodiment. The RAM 102 corresponds to the memory 12 of the first embodiment. The HDD 103 corresponds to the storage device 11 of the first embodiment. The information processing apparatus 100 may be a client apparatus such as a client computer and the like, or may be a server apparatus such as a server computer and the like.

The CPU 101 is a processor including an arithmetic circuit that executes program instructions. The CPU 101 loads at least part of a program and data stored in the HDD 103 to the RAM 102, and executes the program. Note that the CPU 101 may include multiple processor cores, and the information processing apparatus 100 may include multiple processors. Thus, processes described below may be executed in parallel by using multiple processors or processor cores. A set of multiple processors (a multiprocessor) may be referred to as a “processor”.

The RAM 102 is a volatile semiconductor memory that temporarily stores a program executed by the CPU 101 and data used for operations by the CPU 101. The information processing apparatus 100 may include other types of memories than a RAM, and may include a plurality of memories.

The HDD 103 is a non-volatile storage device that stores software programs (such as an operation system (OS), middleware, application software, and the like) and data. The programs include a cache control program. The information processing apparatus 100 may include other types of storage devices such as a flash memory, an SSD, and the like, and may include a plurality of non-volatile storage devices.

The video signal processing unit 104 outputs an image to a display 111 connected to the information processing apparatus 100, in accordance with an instruction from the CPU 101. Examples of the display 111 include a cathode ray tube (CRT) display, a liquid crystal display (LCD), a plasma display, an organic electro-luminescence (OEL) display, and the like.

The input signal processing unit 105 obtains an input signal from an input device 112 connected to the information processing apparatus 100, and outputs the input signal to the CPU 101. Examples of the input device 112 include a pointing device (such as a mouse, a touch panel, a touch pad, a trackball, and the like), a keyboard, a remote controller, a button switch, and the like. A plurality of types of input devices may be connected to the information processing apparatus 100.

The media reader 106 is a reading device that reads a program and data stored in a storage medium 113. Examples of the storage medium 113 include a magnetic disc (such as a flexible disk (FD), an HDD, and the like), an optical disc (such as a compact disc (CD), a digital versatile disc (DVD), and the like), a magneto-optical disc (MO), a semiconductor memory, and the like. The media reader 106 reads, for example, a program and data from the storage medium 113, and stores the read program and data in the RAM 102 or the HDD 103.

The communication interface 107 is connected to a network 114, and communicates with other apparatuses via the network 114. The communication interface 107 may be a wired communication interface connected to a communication apparatus such as a switch via a cable, or may be a radio communication interface connected to a base station via a radio link.

Hereinafter, a description will be given of caching of data from the HDD 103 into the RAM 102.

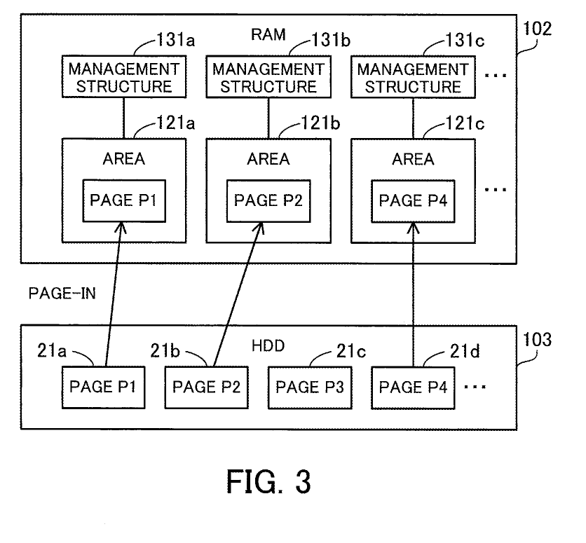

FIG. 3 illustrates an example of cache page management.

The information processing apparatus 100 reads or writes data in response to an access request issued by a process running on the information processing apparatus 100 or another information processing apparatus. Data processing according to the access request is performed on data cached in the RAM 102. If data specified in the access request is not cached in the RAM 102, the information processing apparatus 100 loads the data from the HDD 103 into the RAM 102. Loading of the data from the HDD 103 into the RAM 102 is performed in units of pages of a predetermined size.

In the RAM 102, a plurality of areas each capable of storing one page are reserved in advance. For each of the plurality of areas, a management structure for managing a page stored in the area is generated in advance and stored in the RAM 102. The plurality of areas include areas 121a, 121b, and 121c. The RAM 102 stores a management structure 131a corresponding to the area 121a, a management structure 131b corresponding to the area 121b, and a management structure 131c corresponding to the area 121c. The HDD 103 stores a plurality of pages including a page 21a (P1), a page 21b (P2), a page 21c (P3), and a page 21d (P4).

If an access request specifying a physical address belonging to the page 21a arrives, the information processing apparatus 100 loads the page 21a from the HDD 103 to the area 121a (page-in), for example. Then, the information processing apparatus 100 updates the management structure 131a. Further, if an access request specifying a physical address belonging to the page 21b arrives, the information processing apparatus 100 loads the page 21b from the HDD 103 to the area 121b, for example. Then, the information processing apparatus 100 updates the management structure 131b. Further, if an access request specifying a physical address belonging to the page 21d arrives, the information processing apparatus 100 loads the page 21d from the HDD 103 to the area 121c, for example. Then, the information processing apparatus 100 updates the management structure 131c.

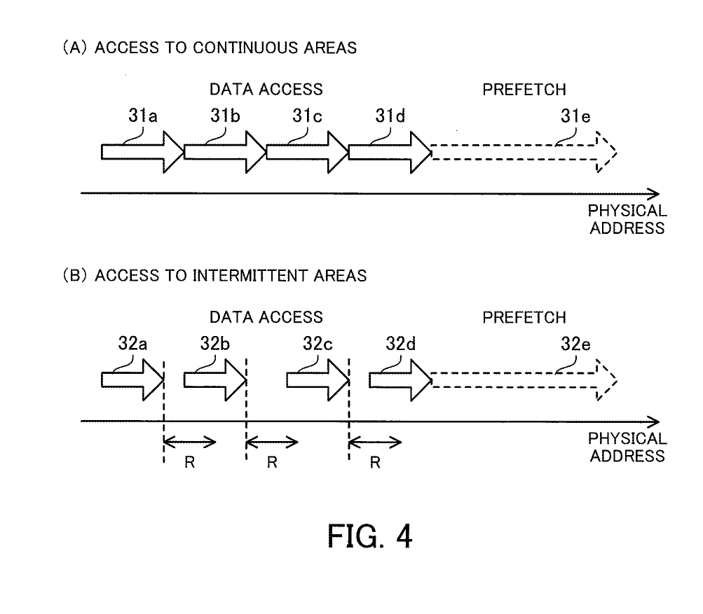

FIG. 4 illustrates an example of sequential data access and prefetch.

The types of data access performed by a process include random access to pages spaced apart from each other in the HDD 103, and sequential data access to adjacent pages in the HDD 103. In the second embodiment, it is assumed that sequential data access is one that requests a plurality of pages in ascending order of physical address in the HDD 103. A set of sequential data access events is often referred to as a “stream”.

The types of sequential data access includes: (A) access to continuous areas and (B) access to intermittent areas. The access to continuous areas is one that requests a page and then requests an adjacent page at a greater physical address than that page. When adjacent pages are sequentially requested by a plurality of access requests, a series of continuous areas are eventually requested. The access to intermittent areas is one that requests a page and then requests a page which has a greater physical address than that page and whose distance from the end of that page is less than a threshold R.

For example, upon accessing continuous areas, data access 31a occurs that requests a certain page. Then, data access 31b occurs that requests a page next to the page requested by the data access 31a. Similarly, data access 31c occurs that requests a page next to the page requested by the data access 31b. Then, data access 31d occurs that requests a page next to the page requested by the data access 31c. The data access 31a, the data access 31b, the data access 31c, and the data access 31d belong to the same stream.

Further, for example, upon accessing intermittent areas, data access 32a occurs that requests a certain page. Then, data access 32b occurs that requests a page near the page requested by the data access 32a. The distance between the end of the data access 32a and the beginning of the data access 32b is less than the threshold R. Similarly, data access 32c occurs that requests a page near the page requested by the data access 32b. The distance between the end of the data access 32b and the beginning of the data access 32c is less than the threshold R. Then, data access 32d occurs that requests a page near the page requested by the data access 32c. The distance between the end of the data access 32c and the beginning of the data access 32d is less than the threshold R. As in the case of the access to continuous areas, the data access 32a, the data access 32b, the data access 32c, and the data access 32d belong to the same stream.

As for sequential data access, since access occurs with regularity, it is possible to find a page that is likely to be requested next. Accordingly, when a stream of access events is detected, the information processing apparatus 100 reads in advance (prefetches) a page from the HDD 103 into the RAM 102.

In the case of the access to continuous areas described above, the information processing apparatus 100 performs prefetch 31e after the data access 31d. In the prefetch 31e, the information processing apparatus 100 prefetches a page which has a greater physical address than the page requested by the data access 31d and which is located within a predetermined distance from the end of the data access 31d. In the case of the access to intermittent areas described above, the information processing apparatus 100 performs prefetch 32e after the data access 32d. In the prefetch 32e, the information processing apparatus 100 prefetches a page which has a greater physical address than the page requested by the data access 32d and which is located within a predetermined distance from the end of the data access 32d.

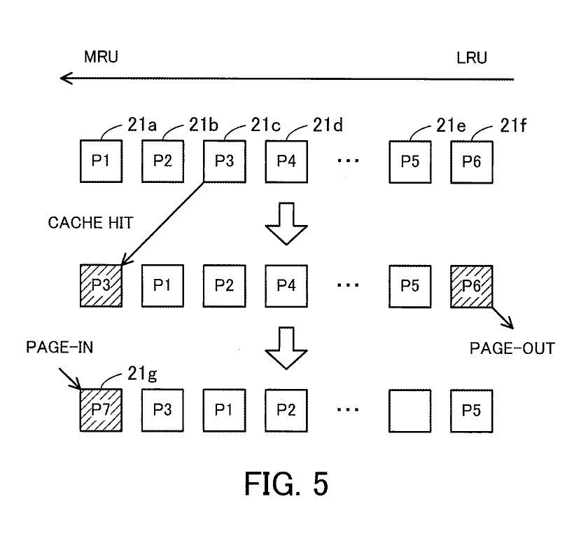

FIG. 5 illustrates an example of an LRU algorithm.

If all the areas of the RAM 102 store pages and if another page that is not cached is requested, the information processing apparatus 100 needs to evict any of the pages in the areas from the RAM 102. In the second embodiment, an LRU algorithm is used as a page replacement algorithm that selects a page to be evicted from among the plurality of cached pages.

The information processing apparatus 100 manages the plurality of pages stored in the RAM 102 by using, for example, a list illustrated in FIG. 5. An MRU page is a page that is most recently used. An LRU page is a page that is least recently used. In this example, the pages 21a, 21b, 21c, and 21d, a page 21e (P5), and a page 21f (P6) are registered in the list. The page 21a is the page at the top of the list, and is the MRU page. The page 21b is the second page from the top of the list; the page 21c is the third page from the top of the list; the page 21d is the fourth page from the top of the list; and the page 21e is the second page from the end of the list. The page 21f is the page at the end of the list, and is the LRU page.

If the cached page 21c is requested (a cache hit occurs), the page 21c is moved to the top of the list to become the MRU page. Accordingly, the pages 21a and 21b are shifted to the LRU side on the list. If a page 21g (P7) is requested (a cache miss occurs), the page 21g is added to the top of the list to become the MRU page. Accordingly, the pages 21a, 21b, 21c, 21d, and 21e are shifted to the LRU side on the list. Further, the page 21f (LRU page) that has been registered at the end of the list is evicted from the list.

Thus, according to the common LRU algorithm, the page 21f is removed from the RAM 102 (page-out), and the page 21g is loaded into the RAM 102 (page-in). That is, the page 21f is replaced with the page 21g.

However, if the common LRU algorithm is applied collectively to the pages loaded by prefetch and the other pages, pages that are less likely to be used in the future are likely to remain in the RAM 102. This might reduce the usage efficiency of the RAM 102. That is, when the progress of a certain stream stops (a certain stream disappears), pages prefetched for the stream (pages related to the stream that has disappeared) become less likely to be used in the future. In view of this, the information processing apparatus 100 preferentially removes the pages related to the stream that has disappeared over a page selected by the LRU algorithm.

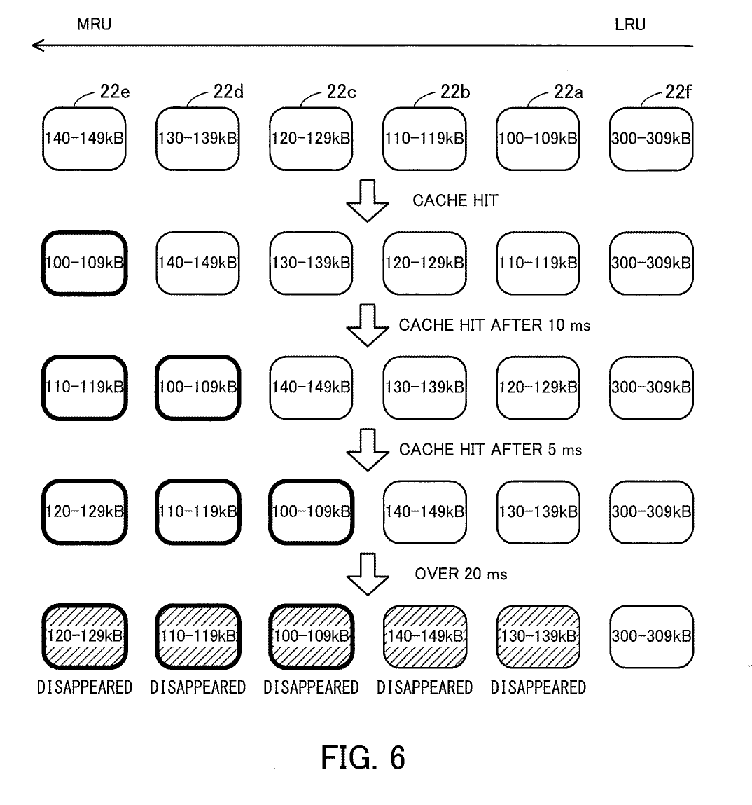

FIG. 6 illustrates an example of pages related to a stream that has disappeared.

In this example, each page has a size of 10 kilobytes (kB). The address range illustrated in FIG. 6 is the physical address range of the HDD 103. First, a page 22f of 300-309 kB is loaded into the RAM 102 with a method other than prefetch. Then, a page 22a of 100-109 kB, a page 22b of 110-119 kB, a page 22c of 120-129 kB, a page 22d of 130-139 kB, and a page 22e of 140-149 kB are sequentially loaded into the RAM 102 by prefetch.

When the page 22a is requested by a stream, the page 22a becomes the MRU page. Then, when the page 22b is requested 10 milliseconds (ms) after the page 22a was requested, the page 22b becomes the MRU page. In this case, since the time interval between the access requests is sufficiently short, the stream is determined not to have disappeared. Then, when the page 22c is requested 5 ms after the page 22b was requested, the page 22c becomes the MRU page. In this case, since the time interval between the access requests is sufficiently short, the stream is determined not to have disappeared.

Then, although 20 minutes have elapsed from when the page 22c was requested, any of the pages 22a, 22b, 22c, 22d, and 22e is not requested. In this case, the information processing apparatus 100 determines that the stream has disappeared. Then, the pages 22a, 22b, 22c, 22d, and 22e prefetched for the stream that has disappeared are allowed to be removed. Note that although the threshold for elapsed time is set to 20 ms in this example, the threshold is determined by a method described below. The pages that are allowed to be removed are all the pages related to the stream that has disappeared, including the pages 22a, 22b, and 22c that are used after having been cached, as well as the pages 22d and 22e that are not used after having been cached.

Note that, in the second embodiment, the pages related to the stream that has disappeared are not immediately removed from the RAM 102, but are removed when prefetch is performed or when a cache miss occurs. If the pages related to the stream that has disappeared are remaining in the RAM 102, these pages are preferentially removed over the page selected by the LRU algorithm. Accordingly, the pages 22a, 22b, 22c, 22d, and 22e are preferentially removed over the page 22f.

Hereinafter, a description will be given of functions of the information processing apparatus 100.

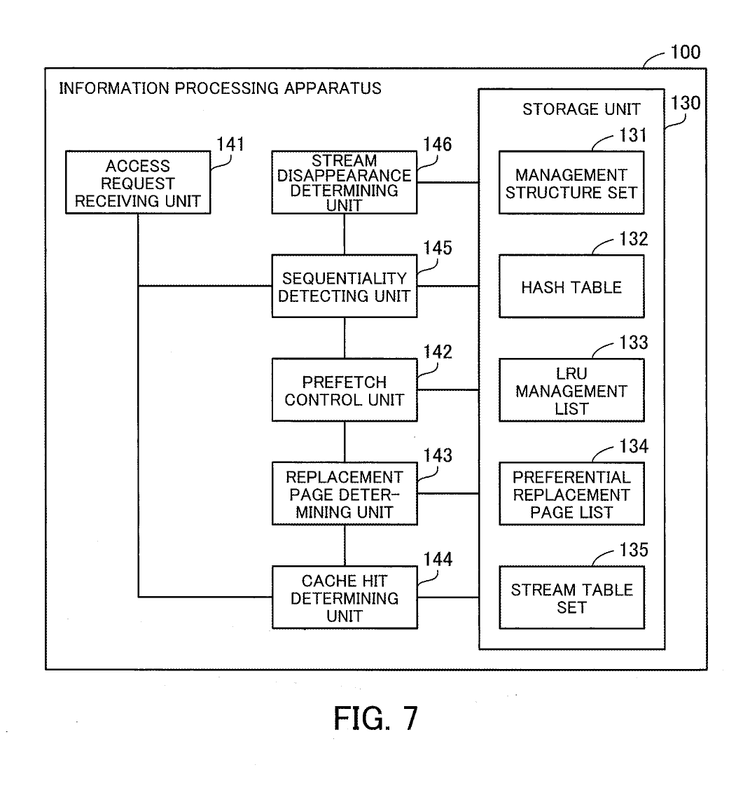

FIG. 7 is a block diagram illustrating exemplary functions of the information processing apparatus 100.

The information processing apparatus 100 includes a storage unit 130, an access request receiving unit 141, a prefetch control unit 142, a replacement page determining unit 143, a cache hit determining unit 144, a sequentiality detecting unit 145, and a stream disappearance determining unit 146. The storage unit 130 is implemented using a storage area reserved in the RAM 102 or the HDD 103, for example. The access request receiving unit 141, the prefetch control unit 142, the replacement page determining unit 143, the cache hit determining unit 144, the sequentiality detecting unit 145, and the stream disappearance determining unit 146 are implemented using program modules executed by the CPU 101, for example.

The storage unit 130 stores a management structure set 131, a hash table 132, an LRU management list 133, a preferential replacement page list 134, and a stream table set 135.

The management structure set 131 is a set of management structures for managing pages that are cached in the RAM 102. Each management structure corresponds to an area capable of storing one page. A plurality of areas are reserved in advance in the RAM 102, and the management structure set 131 is generated in advance corresponding to the plurality of areas. The management structure set 131 includes the management structures 131a, 131b, and 131c illustrated in FIG. 3.

The hash table 132 is a table in which a hash value of a stream ID for identifying each stream is associated with a management structure for managing a page that is prefetched for the stream. With use of the hash table 132, it is possible to quickly find a management structure related to a stream, based on the stream ID of the stream.

The LRU management list 133 is a list that represents the usage of the pages cached in the RAM 102. The LRU management list 133 is used by the LRU algorithm. The LRU management list 133 indicates the order of pages (order from the MRU page to the LRU page) illustrated in FIG. 5. In order to facilitate page management, the LRU management list 133 includes a pointer to a management structure for a corresponding page. With use of the LRU management list 133, it is possible to select a page to be paged out. In the case where the information processing apparatus 100 uses a page replacement algorithm other than the LRU algorithm, information corresponding to that page replacement algorithm is stored in the storage unit 130 in place of the LRU management list 133.

The preferential replacement page list 134 is a list indicating a candidate for a page that is preferentially paged out over a page (LRU page) that is selected based on the LRU management list 133. Pages indicated in the preferential replacement page list 134 are pages related to a stream that has disappeared, and less likely to be used in the future. In order to facilitate page management, the preferential replacement page list 134 includes a pointer to a management structure for a corresponding page.

The stream table set 135 is a set of stream tables for managing streams. Each stream table corresponds to one stream. The same number of stream tables as the maximum number of streams detectable in the information processing apparatus 100 are generated in advance. It is preferable that a large number of stream tables are included in the stream table set 135. For example, about several thousand to ten thousand stream tables are included. With use of the stream table set 135, a stream of sequential access events is detected, and a stream ID is assigned to the detected stream.

The access request receiving unit 141 receives an access request issued by an application process running on the information processing apparatus 100 or an access request issued by another information processing apparatus. The access request is a read request or a write request. A read request includes address information indicating an area in the HDD 103 where target data is stored. The address information includes, for example, the starting physical address and the data length. A write request includes data to be written, and address information indicating the area in the HDD 103 where the data is to be stored. In the following, it is generally assumed that the access request is a read request.

The prefetch control unit 142 prefetches a page in response to an instruction from the sequentiality detecting unit 145. That is, the prefetch control unit 142 loads a page specified by the sequentiality detecting unit 145 from the HDD 103 into the RAM 102. In this step, the prefetch control unit 142 queries the replacement page determining unit 143 for an area where the page is to be stored. The prefetch control unit 142 overwrites the area determined by the replacement page determining unit 143 with the page read from the HDD 103. Further, the prefetch control unit 142 updates the management structure corresponding to the overwritten area such that the management structure corresponds to the prefetched page.

The replacement page determining unit 143 determines an area into which a page is to be read, in response to a query from the prefetch control unit 142 or the cache hit determining unit 144. This operation includes selecting a page to be paged out from among pages cached in the RAM 102 (including those prefetched and those not prefetched). If the preferential replacement page list 134 is not empty, the replacement page determining unit 143 preferentially selects the pages indicated in the preferential replacement page list 134. On the other hand, if the preferential replacement page list 134 is empty, the replacement page determining unit 143 selects a page according to the LRU algorithm. In the latter case, the replacement page determining unit 143 refers to and updates the LRU management list 133.

The cache hit determining unit 144 provides requested data or writes data, in accordance with the access request received by the access request receiving unit 141. If the target page is not cached in the RAM 102, the cache hit determining unit 144 queries the replacement page determining unit 143 for an area where the target page is to be stored. The cache hit determining unit 144 overwrites the area determined by the replacement page determining unit 143 with the page read from the HDD 103. Further, the cache hit determining unit 144 updates the management structure corresponding to the overwritten area such that the management structure corresponds to the loaded page. If the target page is cached in the RAM 102, the cache hit determining unit 144 updates the LRU management list 133 such that the target page becomes the MRU page.

Then, the cache hit determining unit 144 performs data processing on the target page in the RAM 102. If the access request is a read request, the cache hit determining unit 144 transmits the requested data to the source of the access request. If the access request is a write request, the cache hit determining unit 144 updates a page and transmits the results to the source of the access request.

The sequentiality detecting unit 145 monitors access requests received by the access request receiving unit 141. The sequentiality detecting unit 145 detects sequential access by using the stream table set 135, and determines a stream to which each access belongs. The sequentiality detecting unit 145 determines pages to be prefetched in accordance with the progress of the stream (a specified increment in physical address), and instructs the prefetch control unit 142 to perform prefetch. Further, each time the access request receiving unit 141 receives an access request, the sequentiality detecting unit 145 instructs the stream disappearance determining unit 146 to determine whether there is a stream that has disappeared.

The stream disappearance determining unit 146 determines whether any of the plurality of streams managed by the stream table set 135 has disappeared, in response to an instruction from the sequentiality detecting unit 145. More specifically, the stream disappearance determining unit 146 calculates, for each stream, the difference between the time when the last access request was received and the current time (the elapsed time). The stream disappearance determining unit 146 determines a stream having an elapsed time greater than a threshold as a stream that has disappeared. The threshold for elapsed time is determined for each stream, based on the time interval between access requests in the past.

If a stream that has disappeared is detected, the stream disappearance determining unit 146 finds pages related to the stream that has disappeared, by using the hash table 132. The stream disappearance determining unit 146 updates the preferential replacement page list 134 such that the found pages are added to the pages indicated in the preferential replacement page list 134. Thus, the pages related to the stream that has disappeared are preferentially removed from the RAM 102 over the other pages.

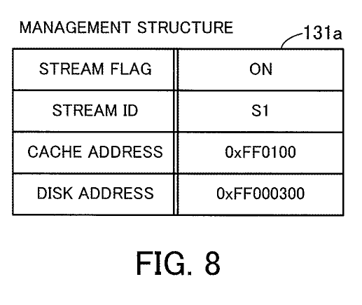

FIG. 8 illustrates an example of a management structure.

The management structure set 131 includes the management structure 131a. The management structure 131a corresponds to the area 121a in the RAM 102. The management structure 131a includes a stream flag, a stream ID, a cache address, and a disk address.

The stream flag indicates whether the page stored in the area 121a is a page prefetched based on a stream. When the stream flag is “ON” (or it indicates that the stored page is a page prefetched based on a stream. When the stream flag is “OFF” (or “0”), it indicates that the stored page is not a page prefetched based on a stream. The default value of the stream flag is “OFF”.

If the stream flag is “ON”, the stream ID indicates a stream which caused prefetch. If the stream flag is “OFF”, the stream ID may be “NULL” or “0”.

The cache address is a physical address in the RAM 102 that identifies the area 121a. The cache address is, for example, the physical address of the beginning of the area 121a. Since the management structure 131a is associated with the area 121a in advance, the cache address is fixed when the management structure 131a is generated. The disk address is a physical address indicating the location in the HDD 103 where the page stored in the area 121a is present. The disk address is, for example, the physical address of the beginning of the page. When the area 121a is overwritten with a page, the disk address in the management structure 131a is updated.

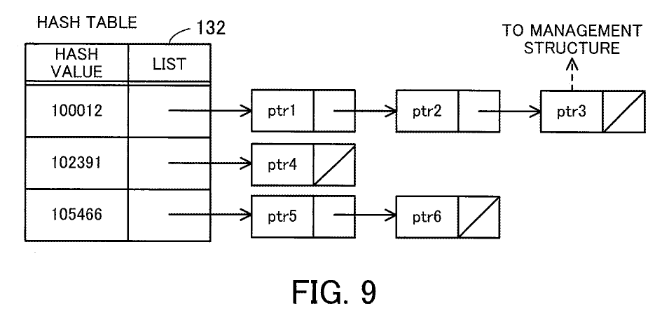

FIG. 9 illustrates an example of the hash table 132.

The hash table 132 includes a plurality of pairs of a hash value and a link to a linked list. The hash value registered in the hash table 132 is a hash value of a stream ID that is calculated using a predetermined hash function. The hash function used is one that has a sufficiently low probability of collision, which occurs when the same hash value is generated from different stream IDs.

A linked list may be referenced based on the hash value of the stream ID. A linked list is a list in which one or more pointers are linked. Each pointer included in the linked list points to any of the management structures included in the management structure set 131. The pointer may be a physical address in the RAM 102 indicating a location where a management structure is stored, or may be a structure ID assigned in advance to a management structure.

The hash table 132 may be regarded as a table in which a stream ID is associated with a management structure including the stream ID. By using the hash table 132, it is possible to find all the management structures related to a stream.

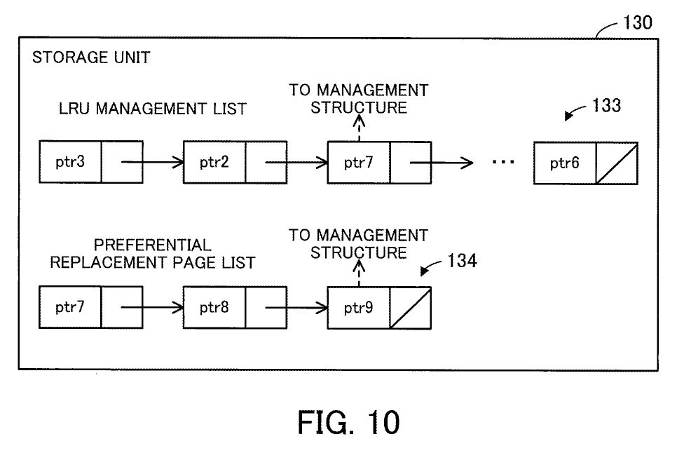

FIG. 10 illustrates an example of the LRU management list 133 and the preferential replacement page list 134.

The LRU management list 133 is a linked list in which a plurality of pointers each indicating a management structure are linked. As mentioned above, the pointer may be a physical address indicating a location where a management structure is stored, or may be a structure ID assigned in advance to a management structure. The pointer at the top of the LRU management list 133 points to a management structure corresponding to the MRU page. The pointer at the end of the LRU management list 133 points to a management structure corresponding to the LRU page.

When a page hit occurs to a certain page, a pointer pointing to a management structure corresponding to the page is moved to the top of the LRU management list 133. When a certain page is paged out from an area, another page is read into the same area, and therefore a pointer pointing to a management structure corresponding to the read page is moved to the top of the LRU management list 133. In the case of selecting a page to be removed based on the LRU algorithm, a page corresponding to a management structure pointed to by a pointer at the end of the LRU management list 133 is selected.

The preferential replacement page list 134 is a linked list in which one or more pointers each indicating a management structure are linked. As mentioned above, the pointer may be a physical address indicating a location where a management structure is stored, or may be a structure ID assigned in advance to a management structure. The page corresponding to a management structure pointed to by a pointer is a page related to a stream that is determined to have disappeared by the stream disappearance determining unit 146.

When a page related to a stream that has disappeared is detected, a pointer pointing to a management structure corresponding to the detected page is added to the end of the preferential replacement page list 134. When the page related to a stream that has disappeared is removed from the RAM 102, a pointer indicating a management structure corresponding to the page that is removed is removed from the preferential replacement page list 134. If a plurality of pointers are included in the preferential replacement page list 134, the plurality of pointers may be selected in arbitrary order. For example, the pointers are selected from the top.

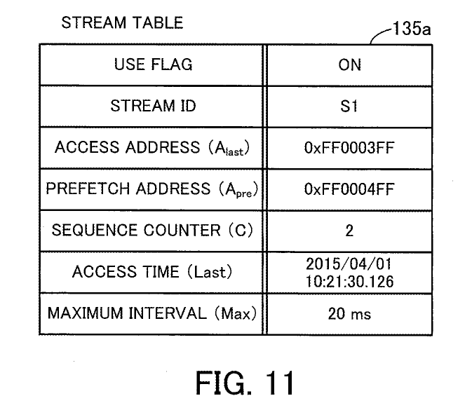

FIG. 11 illustrates an example of a stream table.

The stream table set 135 includes a stream table 135a. The stream table 135a includes a use flag, a stream ID, an access address (Aₗₐₛₜ), a prefetch address (Aₚᵣₑ) a sequence counter (C), access time (Last), and the maximum interval (Max).

The use flag indicates whether the stream table 135a is used. The stream ID is an identification number assigned to a stream managed by the stream table 135a. When a previous stream managed by the stream table 135a has disappeared, then the stream table 135a may be used for managing a new stream that is detected thereafter. In this case, a stream ID registered in the stream table 135a is replaced with a new stream ID.

The access address indicates the end of the last address range specified by the stream managed by the stream table 135a. That is, the access address is a physical address in the HDD 103 indicating the end of the last data used by the stream. The prefetch address is a physical address in the HDD 103 indicating the end of the last prefetched page for the stream managed by the stream table 135a.

The sequence counter indicates how many times an access request satisfying a predetermined condition is detected. In other words, the sequence counter indicates the number of “sequential access events” belonging to the stream managed by the stream table 135a. The predetermined condition is that the beginning of the address range specified in an access request is located between an access address Aₗₐₛₜ and the access address Aₗₐₛₜ+R.

The access time indicates time when the last access request belonging to the stream managed by the stream table 135a was received. The access time is measured in units of milliseconds, for example. The access time is updated in response to arrival of a new access request. The maximum interval indicates the longest time interval from reception of an access request to reception of the next access request belonging to the same stream, among the actual time records. The time interval is measured in units of milliseconds, for example. The time interval may be calculated as the difference between the access time registered in the stream table 135a and the current time when a new access request arrives. The maximum interval is updated when the latest time interval is greater than the existing maximum interval.

The following describes a processing procedure performed by the information processing apparatus 100.

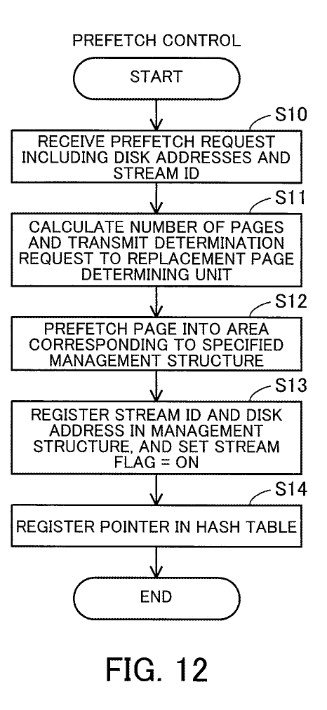

FIG. 12 is a flowchart illustrating an example of the procedure of prefetch control.

(S10) The prefetch control unit 142 receives a prefetch request from the sequentiality detecting unit 145. The prefetch request includes disk addresses indicating the beginning and the end of one or more pages to be prefetched and a stream ID.

(S11) The prefetch control unit 142 calculates the number of pages to be prefetched, based on the disk addresses included in the prefetch request. The prefetch control unit 142 transmits a determination request including the number of pages to the replacement page determining unit 143.

(S12) The prefetch control unit 142 receives the same number of pointers of management structures as the number of pages calculated in step S11 from the replacement page determining unit 143. The prefetch control unit 142 acquires a cache address from the management structure pointed to by the received pointer. The prefetch control unit 142 copies a page in the HDD 103 indicated by the disk addresses included in the prefetch request to an area in the RAM 102 indicated by the cache address. In the case of prefetching two or more pages, the management structures may be used in arbitrary order.

(S13) The prefetch control unit 142 updates the stream ID, the disk address, and the stream flag of the management structure pointed to by the pointer received in step S12. The stream ID to be registered in the management structure is the one included in the prefetch request. The disk address to be registered in the management structure is a physical address in the HDD 103 indicating the beginning of the page. In the case where two or more pages are prefetched, the disk address differs from management structure to management structure. The stream flag to be registered in the management structure is “ON” (or “1”).

(S14) The prefetch control unit 142 calculates a hash value of the stream ID included in the prefetch request, by using a predetermined hash function. The prefetch control unit 142 searches the hash table 132 to find a linked list corresponding to the calculated hash value, and adds the pointer received in step S12 to the end of the linked list.

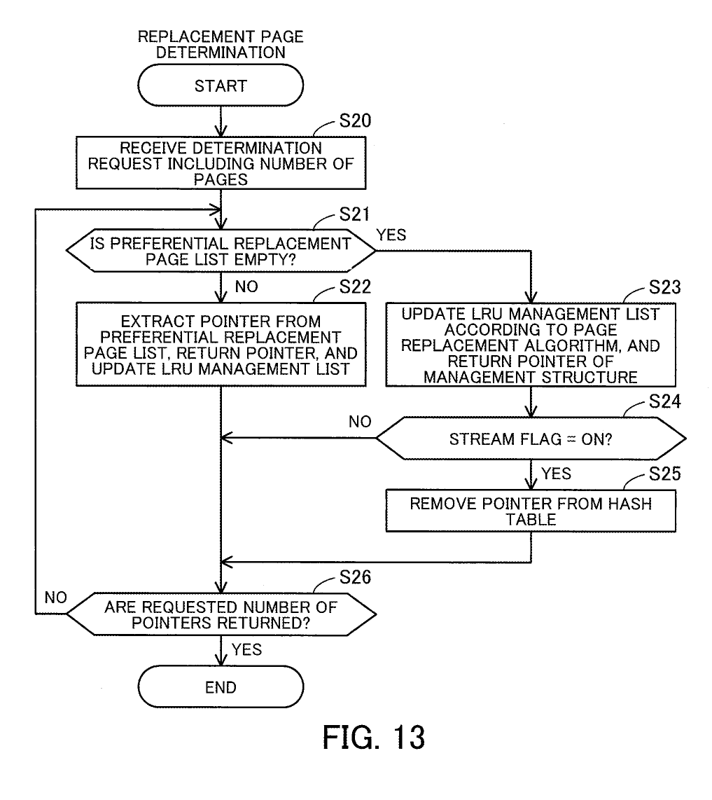

FIG. 13 is a flowchart illustrating an example of the procedure of replacement page determination.

(S20) The replacement page determining unit 143 receives a determination request including the number of pages, from the prefetch control unit 142 or the cache hit determining unit 144.

(S21) The replacement page determining unit 143 determines whether the preferential replacement page list 134 is empty (whether no pointer is registered). If the preferential replacement page list 134 is empty, the process proceeds to step S23. If the preferential replacement page list 134 is not empty (one or more pointers are registered), the process proceeds to step S22.

(S22) The replacement page determining unit 143 extracts a pointer (for example, the top pointer) from the preferential replacement page list 134. The extracted pointer is removed from the preferential replacement page list 134. The replacement page determining unit 143 returns the extracted pointer to the source of the determination request. Further, the replacement page determining unit 143 searches the LRU management list 133 to find a pointer pointing to the same management structure as the extracted pointer, and removes the found pointer from the LRU management list 133. Then, the process proceeds to step S26.

(S23) The replacement page determining unit 143 updates the LRU management list 133 in accordance with the LRU algorithm, and selects a pointer of a management structure corresponding to a page to be evicted from the RAM 102. More specifically, the replacement page determining unit 143 moves a pointer at the end of the LRU management list 133 to the top, and selects the pointer moved to the top. However, the replacement page determining unit 143 may use other page replacement algorithms. The replacement page determining unit 143 returns the selected pointer to the source of the determination request.

(S24) The replacement page determining unit 143 acquires a stream flag from the management structure pointed to by the pointer selected in step S23, and determines whether the stream flag is “ON” (or “1”). If the stream flag is “ON”, the process proceeds to step S25. If the stream flag is “OFF” (or “0”), the process proceeds to step S26.

(S25) The replacement page determining unit 143 acquires a stream ID from the management structure pointed to by the pointer selected in step S23, and calculates a hash value of the stream ID. The replacement page determining unit 143 searches the hash table 132 to find a linked list corresponding to the calculated hash value, and finds a pointer pointing to the same management structure as the pointer selected in step S23. The replacement page determining unit 143 removes the found pointer.

(S26) The replacement page determining unit 143 determines whether the same number of pointers as the number of pages specified in the determination request are returned. If the specified number of pointers are returned, the replacement page determination ends. Otherwise, the process returns to step S21.

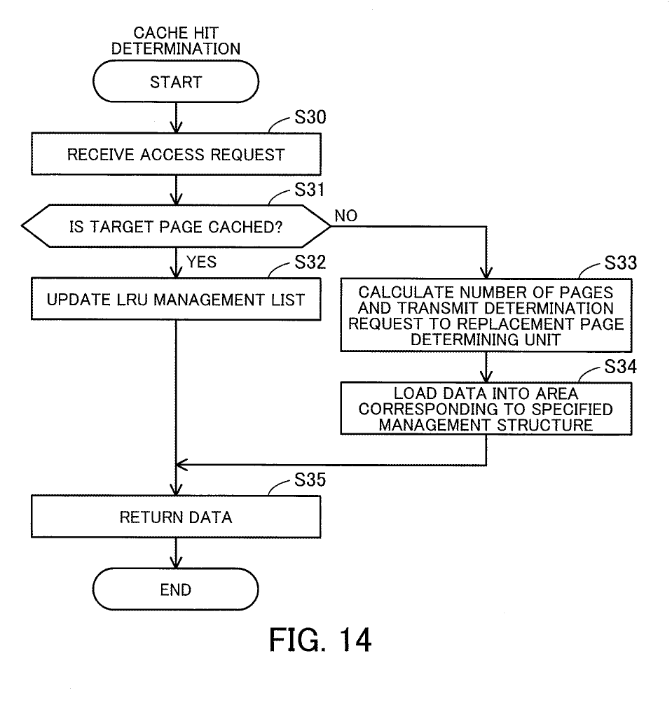

FIG. 14 is a flowchart illustrating an example of the procedure of cache hit determination.

(S30) The cache hit determining unit 144 receives an access request including address information, from the access request receiving unit 141. The address information includes, for example, a physical address in the HDD 103 indicating the beginning of data to be read and the data length.

(S31) The cache hit determining unit 144 specifies one or more target pages, based on the address information included in the access request. The cache hit determining unit 144 determines whether the specified target page is cached in the RAM 102, based on the disk address included in each management structure. If the target page is cached (if a cache hit occurs), the process proceeds to step S32. If the target page is not cached (if a cache miss occurs), the process proceeds to step S33.

(S32) The cache hit determining unit 144 searches the LRU management list 133 to find a pointer pointing to a management structure including the disk address of the target page, and moves the found pointer to the top of the LRU management list 133. In the case where another page replacement algorithm is used, processing in accordance with the used algorithm is performed. Then, the process proceeds to step S35.

(S33) The cache hit determining unit 144 calculates the number of target pages specified in step S31, and transmits a determination request including the number of pages to the replacement page determining unit 143.

(S34) The cache hit determining unit 144 receives the same number of pointers of management structures as the number of pages calculated in step S33 from the replacement page determining unit 143. The cache hit determining unit 144 acquires a cache address pointed to by the received pointer. The cache hit determining unit 144 copies the target page in the HDD 103 to an area in the RAM 102 indicated by the cache address. Further, the cache hit determining unit 144 updates the stream ID, the disk address, and the stream flag in the management structure pointed to by the received pointer. The stream ID to be registered in the management structure is “NULL” (or “0”). The disk address to be registered in the management structure is a physical address in the HDD 103 indicating the beginning of the target page. The stream flag to be registered in the management structure is “OFF” (or “0”).

(S35) The cache hit determining unit 144 extracts data indicated by the address information included in the access request, from the pages cached in the RAM 102, and returns the extracted data to the source of the access request. In the case where the access request is a write request, the cache hit determining unit 144 updates a page cached in the RAM 102 using the data included in the write request, and informs the source of the access request of whether the update is successful. Note that in the case where a cashed page is updated, the page is written back to the HDD 103 immediately after being updated or when the page is evicted from the RAM 102.

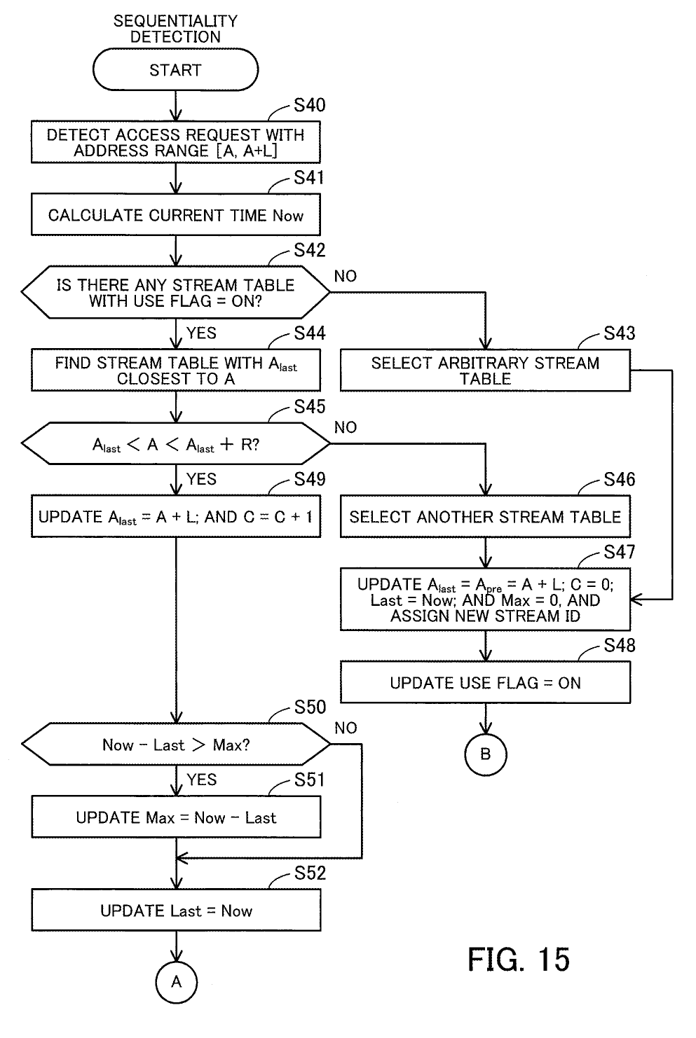

FIG. 15 is a flowchart illustrating an example of the procedure of sequentiality detection.

(S40) The sequentiality detecting unit 145 monitors access requests received by the access request receiving unit 141, and detects an access request with an address range [A, A+L] (an access request including a starting physical address “A” and a data length “L”).

(S41) The sequentiality detecting unit 145 calculates the current time (Now).

(S42) The sequentiality detecting unit 145 finds a stream table with a use flag of “ON” (or “1”), from the stream table set 135. The sequentiality detecting unit 145 determines whether there is such a stream table. If there is such a stream table, the process proceeds to step S44. If not, the process proceeds to step S43.

(S43) The sequentiality detecting unit 145 selects an arbitrary stream table from the stream table set 135. Then, the process proceeds to step S47.

(S44) The sequentiality detecting unit 145 finds a stream table with an access address (Aₗₐₛₜ) closest to A, from among stream tables with a use flag of “ON”.

(S45) The sequentiality detecting unit 145 determines whether the access address (Aₗₐₛₜ) of the stream table found in step S44 satisfies Aₗₐₛₜ<A<Aₗₐₛₜ+R. In the above relationship, “R” is a predetermined threshold for interval of access, and is used for determining whether access is sequential access illustrated in FIG. 4. If the above relationship is satisfied, the processing proceeds to step S49. If not, the processing proceeds to step S46.

(S46) The sequentiality detecting unit 145 selects a stream table with a use flag of “OFF” (or “0”), from the stream table set 135. However, if there is no stream table with a use flag of “OFF” among the stream table set 135, the stream table found in step S44 is selected.

(S47) The sequentiality detecting unit 145 updates the access address (Aₗₐₛₜ), the prefetch address (Aₚᵣₑ), the sequence counter (C), the stream ID, the access time (Last), and the maximum interval (Max) of the stream table selected in step S43 or S46. The access address and the prefetch address are set to the end (A+L) of the address range specified in the access request. The sequence counter is initialized to “0”. The stream ID is set to a new identification number. The access time is set to the current time (Now). However, the access time may be set to an arbitrary value such as “0” or the like. The maximum interval is set to “0”.

(S48) The sequentiality detecting unit 145 updates the use flag of the selected stream table to “ON”. Then, the process proceeds to step S57.

(S49) The sequentiality detecting unit 145 selects the stream table found in step S44. The sequentiality detecting unit 145 updates the access address (Aₗₐₛₜ) and the sequence counter (C) of the selected stream table. The access address is set to the end (A+L) of the address range specified in the access request. The sequence counter is set to a value (C+1) obtained by incrementing the current value of the sequence counter by one.

(S50) The sequentiality detecting unit 145 acquires the access time (Last) from the stream table selected in step S49, and calculates elapsed time by subtracting the access time from the current time. The sequentiality detecting unit 145 acquires the maximum interval (Max) from the selected stream table, and determines whether the calculated elapsed time is greater than the maximum interval. If the elapsed time is greater than the maximum interval, the process proceeds to step S51. Otherwise, the process proceeds to step S52.

(S51) The sequentiality detecting unit 145 updates the maximum interval of the selected stream table to the elapsed time (Now−Last) calculated in step S50.

(S52) The sequentiality detecting unit 145 updates the access time of the selected stream table to the current time. Then, the process proceeds to step S53.

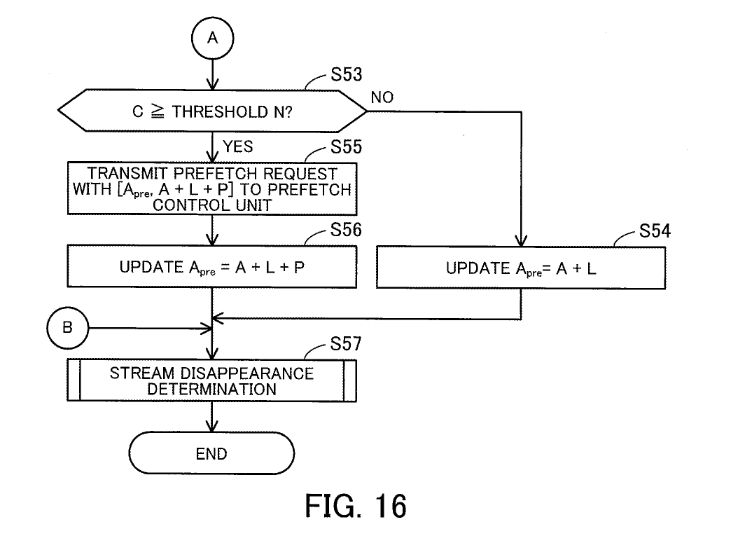

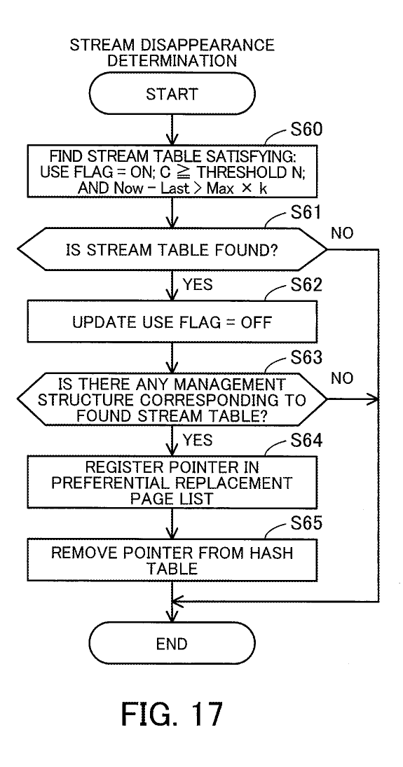

FIG. 16 is a flowchart (continued from FIG. 17) illustrating the example of the procedure of sequentiality detection.

(S53) The sequentiality detecting unit 145 determines whether the sequence counter (C) updated in step S49 is equal to or greater than a threshold N. The threshold N is a threshold for access count for determining whether a set of access events satisfying the relationship indicated in step S45 is a stream. The threshold N is an integer equal to or greater than 2, and is determined in advance. If a relationship C≧N is satisfied, the process proceeds to step S55. If this relationship is not satisfied, the processing proceeds to step S54.

(S54) The sequentiality detecting unit 145 updates the prefetch address (Aₚᵣₑ) of the stream table selected in step S49 to the end (A+L) of the address range specified in the access request. Then, the process proceeds to step S57.

(S55) The sequentiality detecting unit 145 transmits a prefetch request to the prefetch control unit 142. The prefetch request includes the stream ID of the stream table selected in step S49. The prefetch request also includes Aₚᵣₑ as the address of the beginning of a set of pages to be prefetched, and includes A+L+P as the address of the end of the set of pages to be prefetched. Note that “P” indicates the amount of data to be prefetched at one time, and is determined in advance.

(S56) The sequentiality detecting unit 145 updates the prefetch address (Aₚᵣₑ) of the stream table selected in step S49 to a physical address (A+L+P) of in the HDD 103 indicating the end of the prefetched page.

(S57) The sequentiality detecting unit 145 calls the stream disappearance determining unit 146.

FIG. 17 is a flowchart illustrating an example of the procedure of stream disappearance determination.

(S60) The stream disappearance determining unit 146 finds a stream table satisfying the following three conditions, from the stream table set 135. A first condition is that the use flag is “ON”. A second condition is that the sequence counter is equal to or greater than the threshold N. A third condition is that the difference between the current time and the access time (Now−Last) is greater than k times the maximum interval (Max× k). The coefficient “k” is a predetermined value greater than 1, and is used for adjusting the waiting time for a determination of disappearance of a stream. That is, the third condition is that the period of time during which no access request is made is sufficiently longer than the maximum access time interval in the past.

(S61) The stream disappearance determining unit 146 determines whether a stream table satisfying the three conditions is found in step S60. If there is such a stream table, the process proceeds to step S62, and then steps S62 to S65 are performed for each of such stream tables. If there is not such a stream table, the stream disappearance determination ends.

(S62) The stream disappearance determining unit 146 updates the use flag of the stream table found in step S60 from “ON” to “OFF”.

(S63) The stream disappearance determining unit 146 acquires a stream ID from the stream table found in step S60, and calculates the hash value of the stream ID. The stream disappearance determining unit 146 searches the hash table 132 to find a linked list corresponding to the calculated hash value, and finds a management structure pointed to by a pointer included in the linked list (a management structure including the stream ID described above). The stream disappearance determining unit 146 determines whether there is one or more such management structures. If there is such a management structure, the process proceeds to step S64. If there is not such a management structure, the stream disappearance determination ends.

(S64) The stream disappearance determining unit 146 registers a pointer pointing to the management structure found in step S63, in the preferential replacement page list 134.

(S65) The stream disappearance determining unit 146 removes the pointer pointing to the management structure found in step S63, from the linked list found in step S63.

According to the information processing apparatus 100 of the second embodiment, a stream ID that identifies a stream is associated with a prefetched page, and the time interval at which an access request arrives is monitored for each stream. If no access request is made for a stream for a period of time sufficiently longer than the time interval in the past, the stream is determined to have disappeared. Then, pages related to the stream that has disappeared are searched for from among the pages cached in the RAM 102. The pages related to the stream that has disappeared are less likely to be used in the future, and therefore are preferentially removed from the RAM 102 over a page selected by the LRU algorithm. Thus, it is possible to create empty space in the RAM 102 while retaining in the RAM 102 the pages more likely to be used than the pages related to the stream that has disappeared. Accordingly, compared to the case where only the LRU algorithm is used, it is possible to improve the usage efficiency of the cache area.

As mentioned above, the information processing in the first embodiment may be implemented by causing the information processing apparatus 10 to execute a program. The information processing of the second embodiment may be implemented by causing the information processing apparatus 100 to execute a program.

Each program may be recorded in a computer-readable storage medium (for example, the storage medium 113). Examples of storage media include magnetic disks, optical discs, magneto-optical disks, semiconductor memories, and the like. Examples of magnetic disks include FD and HDD. Examples of optical discs include CD, CD-Recordable (CD-R), CD-Rewritable (CD-RW), DVD, DVD-R, and DVD-RW. The program may be stored in a portable storage medium and distributed. In this case, the program may be executed after being copied from the portable storage medium to another storage medium (for example, the HDD 103).

According to one aspect, the usage efficiency of a cache memory in the case where prefetch is performed is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to cache data blocks stored in a storage device; and
a processor configured to perform a procedure including:
detecting a stream of access events satisfying a predetermined rule condition, based on a positional relationship between a plurality of first data blocks that are accessed in the storage device, and generating stream information indicating the stream,
monitoring access to a plurality of second data blocks that are prefetched from the storage device into the memory based on the stream information, and determining whether the stream is ended based on elapsed time from last access to any of the plurality of second data blocks, and
removing at least one of the plurality of second data blocks from the memory when the stream is determined to be ended.

2. The information processing apparatus according to claim 1, wherein the removing at least one of the plurality of second data blocks is preferentially performed over removing a third data block that is cached into the memory using a method other than prefetch based on the stream information.

3. The information processing apparatus according to claim 1, wherein the removing at least one of the plurality of second data blocks includes removing the second data block that is not accessed after being prefetched into the memory.

4. The information processing apparatus according to claim 1, wherein:
the monitoring access to the plurality of second data blocks includes calculating a time interval from one access event to any of the second data blocks to a next access event to any of the second data blocks; and
the determining whether the stream is ended includes calculating a threshold based on a maximum value of the time interval, and determining that the stream is ended when the elapsed time is greater than the threshold.

5. A cache control method comprising:
detecting, by a processor, a stream of access events satisfying a predetermined rule condition, based on a positional relationship between a plurality of first data blocks that are accessed in a storage device, and generating stream information indicating the stream;
monitoring, by the processor, access to a plurality of second data blocks that are prefetched from the storage device into a memory based on the stream information, and determining whether the stream is ended based on elapsed time from last access to any of the plurality of second data blocks; and
removing, by the processor, at least one of the plurality of second data blocks from the memory when the stream is determined to be ended.

6. A non-transitory computer-readable storage medium storing a computer program that causes a computer to perform a procedure comprising:
detecting a stream of access events satisfying a predetermined rule condition, based on a positional relationship between a plurality of first data blocks that are accessed in a storage device, and generating stream information indicating the stream;
monitoring access to a plurality of second data blocks that are prefetched from the storage device into a memory based on the stream information, and determining whether the stream is ended based on elapsed time from last access to any of the plurality of second data blocks; and
removing at least one of the plurality of second data blocks from the memory when the stream is determined to be ended.
